(19) United States
(12) Patent Application Publication
(10) Pub. No.: US 2024/0106899 A1
(43) Pub. Date: Mar. 28, 2024

(54) TECHNIQUES FOR ADJUSTING NETWORK-CONNECTED DEVICE FUNCTIONALITY BASED ON MODES

(71) Applicant: Apple Inc., Cupertino, CA (US)

(72) Inventors: Gregory S. Johnson, Campbell, CA (US); Amber N. Johnson, Campbell, CA (US)

(73) Assignee: Apple Inc., Cupertino, CA (US)

(21) Appl. No.: 18/367,296

(22) Filed: Sep. 12, 2023

Related U.S. Application Data
(60) Provisional application No. 63/376,739, filed on Sep. 22, 2022.

(51) Int. Cl. H04L 67/12; H04W 64/00

(52) U.S. Cl. CPC H04L 67/12; H04W 64/003

(57) ABSTRACT

When a mobile device comes within a proximity of one or more accessories, the one or more accessories can generate an indication for sending to the mobile device. The indication can be based on a state of the one or more accessories and can include state information. The indication can be used to communicate state information about the one or more accessories to the mobile device.

### CROSS-REFERENCES TO RELATED APPLICATIONS

This application claims the benefit of U.S. Provisional Patent Application No. 63/376,739, filed on Sep. 22, 2022, which is herein incorporated by reference in its entirety for all purposes.

### TECHNICAL FIELD

The disclosure generally relates to interactions between accessory devices and computing devices that are connected on a local network.

### BACKGROUND

Home automation is becoming more and more popular. Starting with automatic clothes and dish washing machines years ago to the smart (e.g., network-connected and controllable) fixtures, appliances, and accessories of today, more and more people are automating their homes. With the increasing availability of smart accessories and appliances comes more ways to control these smart devices. For example, a software application on a user's mobile device can be configured to control individual accessories, appliances, and/or fixtures in the user's home or office.

### SUMMARY

A system of one or more computers can be configured to perform particular operations or actions during specific instances by virtue of having software, firmware, hardware, or a combination of them installed on the system, which in operation can cause the system to perform the actions. One or more computer programs can be configured to perform particular operations or actions by virtue of including instructions that, when executed by data processing apparatus, cause the apparatus to perform the actions. One general aspect includes a computer-implemented method. The computer-implemented method can include determining that a new mobile device has come within proximity of a set of other devices on a network. The computer-implemented method can also include identifying a mode associated with at least one of the set of devices, where the mode identifies one or more settings for various devices within the set of devices. The computer-implemented method can also include generating an indication based at least in part on the mode that can be used to communicate settings information regarding the mode to the new mobile device.

### DESCRIPTION OF DRAWINGS

FIG. 1 shows an example home environment.

FIG. 2 shows an example network configuration.

FIG. 3 is a block diagram of an example system for managing smart devices.

FIG. 4 is an illustration of an example house having various smart devices.

FIG. 5 is an illustration of an example house having various smart devices including mobile devices.

FIG. 6 is a flow diagram of an example process for implementing the techniques described herein.

FIG. 7 shows a simplified block diagram of an example system architecture for a controller.

FIG. 8 shows a simplified block diagram of an example system architecture for an accessory.

### DETAILED DESCRIPTION

Certain embodiments of the present disclosure relate to devices, computer-readable medium, and methods for implementing various techniques for various features of adjusting network-connected device functionality based on modes. In the following description, various embodiments will be described. For purposes of explanation, specific configurations and details are set forth in order to provide a thorough understanding of the embodiments. However, it will also be apparent to one skilled in the art that the embodiments may be practiced without the specific details. Furthermore, well-known features may be omitted or simplified in order not to obscure the embodiment being described.

Examples of the present disclosure are directed to, among other things, methods, systems, devices, and computer-readable media for controlling mobile devices and smart devices.

Home automation includes smart devices in homes which are connected to a network for remote access and control. Smart devices can be referred to as network-connected devices. Smart devices can include controllers and accessories (for example, lamps, lights, fans, etc.). Controllers can be any device that is capable of sending a control instruction to a controllable device including resident devices (for example, smart speakers, smart televisions, etc., that may not regularly be moved) and mobile devices (for example, smart phones, tablets, laptops, etc.). Some devices can be both resident devices and mobile devices (for example, tablets and laptops). A user can control smart devices both by directly interacting with a smart device's user interface (whether a graphical user interface on a screen or through other interface elements such as buttons), or through use of a controller. An accessory can be any device that is capable of receiving a control instruction (for example, from a controller) and acting on it (e.g., changing its internal settings or its state). Controllers can also receive a control instruction in some situations and act on it. A user can generate service groups of related smart devices (e.g., groups of related smart devices and/or groups of smart devices to be controlled together) and control smart devices and service groups by generating settings for common scenarios as described herein.

Users can control the functionality of their smart devices through the use of settings. Users can enable certain settings on their smart devices to enable, delay, or block different types of communication and/or other functionality. For example, a user may create a “deep work” set of settings for a smart device that prevents non-essential or non-emergency related notifications and/or disables certain functionality (for example, applications).

However, some of these settings may sometimes only apply to a particular smart device. However, users often have multiple smart devices such that they want the settings for a particular smart device to propagate similar settings to their other smart devices, or to the smart devices of others. For example, a user may want the “deep work” set of settings on a smartphone to affect the settings on a laptop, by disabling email notifications. To coordinate settings across multiple smart devices, the user can create a mode which propagates device-specific (or device category-specific) settings to each smart device. For example, the techniques described herein can enable the “deep work” mode to propagate specific settings to various different devices throughout a space (e.g., within a local network or even across grouped devices that might be on separate networks).

When a mode is enabled on a controller, the controller can enable the same mode on smart devices within a proximity. For example, a mode enabled on a smartphone can enable certain settings on the smartphone and (potentially different) specific settings on a laptop and/or smart media player within a proximity of the smartphone. Similarly, when such a mode is activated, specific settings may also be propagated to various other smart devices within the network or within a proximity. The specific settings for a device, group of devices, and/or category of devices that correspond to a mode can be different even if all the devices are in a corresponding mode.

On the other hand, resident devices and accessories tend to have different functionality than mobile devices due to differences in smart device usage. Resident devices and accessories tend to be stationary, such as in a home, office, park, etc. Modes for controlling smart devices can be activated by manual selection on a controller (for example, a mobile device or a resident device) or triggered by a triggering event. It can be desirable for the mode of a controller to enable the same mode on other smart devices under certain conditions. For example, a user may be at home and activate a “baby sleeping” mode on their smartphone. The “baby sleeping” mode can activate settings on the smartphone that puts the smartphone on silent. Similarly, the “baby sleeping” mode can be enabled on other smart devices in the home. For example, smart devices that typically make a chime when the doorbell rings may lower (or turn off) their volume.

Modes can affect settings differently on different devices, groups of devices, and/or categories of devices. Categories of devices can be defined in many different ways, including by the user themselves. Example device categories can include mobile devices, smartphones, laptops, smart speakers, smart lights, thermostats, resident devices, fans, smart media players, smart thermostats, etc. Groups of devices can include devices of multiple categories and can include a subset of devices with the same device category (for example, 2 of 3 smart speakers in a home). For example, the aforementioned “baby sleeping” mode may lower the volume for all devices in the group of smart devices that are on the side of the house where the baby is sleeping. In one example, the smart speakers and the smart television (TV) on the side of the house where the baby sleeps lower their volume, while the smart speakers and the smart TV on the other side of the house don't change their volume settings. Additionally, smart devices may be grouped into categories based on their functionality. For example, two smart devices that are seemingly unrelated (e.g., a smart thermostat and a smart television streaming device) may both have a speaker. Thus, they may be grouped together based on their ability to make noise. In which case, either the “deep work” or “baby sleeping” modes may include settings that affect both (e.g., reduce speaker volume).

Examples of the present disclosure are directed to, among other things, methods, systems, devices, and computer-readable media for adjusting smart device (e.g., both controllers and accessories) functionality based on modes. When a mode is activated on a controller the mode can also be enabled on other smart devices (for example, a mobile device, a resident device and/or an accessory) within a proximity. In some examples, the mode activated by a controller can be an input for selection of which mode to trigger on the smart devices within a proximity.

In some examples, a controller with a mode enabled can only enable the same mode on nearby smart devices if the particular controller is authorized. As such, in some examples, only when an authorized controller with a mode activated comes within a proximity of smart devices will a mode activated be enabled on the smart devices. For example, when a user comes home, the mode activated on their mobile device(s) can trigger the same mode on some or all smart devices in the home. In contrast, if a friend of the user comes to the home, the mode activated on the friend's mobile device (which is not authorized) may not enable the same mode on some or all smart devices in the home.

Similarly, when an application (app) on a smart device performs certain actions, the app can trigger a mode or one or more settings for smart devices within a proximity of the smart device. For example, if a user starts a video conference call using an app, the mobile device can trigger settings for nearby smart devices such as causing a nearby light to turn on for better video conferencing lighting and music on a speaker to lower volume or cease playing.

Similarly, controllers (and other smart devices) can broadcast their mode when other (e.g., newly arrived) smart devices enter a proximity. For example, a user may have set a particular mode with regard to a somber event at their home. When friends or family arrive, one or more of the smart devices (for example, a controller) can broadcast the mode and/or related settings to the newly arrived smart devices as described herein. In this example, the broadcasted settings or recommendations for settings associated with the mode can include disabling the receipt of non-emergency phone calls or silencing their ringtones.

The mode can affect a subset of the smart devices in a home. For example, a user may set a ‘work’ mode on their mobile device in their home office. The mobile device, as a controller, can enable a work mode on smart devices within a proximity of that mobile device while smart devices in other parts of the house may not enter a work mode.

### Example Environment

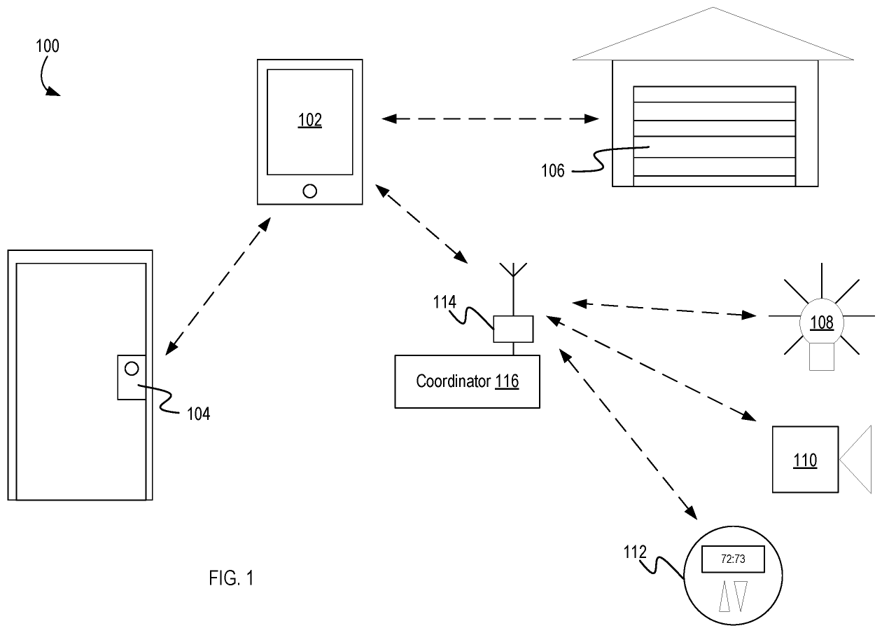

FIG. 1 shows an example home environment 100. Home environment 100 includes a controller 102 that can communicate with various smart devices (for example, mobile devices, resident devices, and accessories) located in the environment. Controller 102 can include, for example, a desktop computer, laptop computer, tablet computer, smart phone, wearable computing device, personal digital assistant, a smart router, a smart wireless access point, or any other computing device or set of devices that is capable of communicating command-and-control messages to accessories and presenting a user interface to allow a user to indicate desired operations on the accessories. In some embodiments, controller 102 can be implemented using multiple discrete devices. For example, there can be a base station that communicates with smart devices and that can be installed in a fixed location in environment 100, and one or more mobile remote-control stations (e.g., a handheld or wearable device such as a mobile phone, tablet computer, smart watch, eyeglasses, etc.) that provide a user interface and communicate with the base station to effect control over smart devices. Controllers 102 can control other smart devices, including other controllers 102 as described herein. In some embodiments, the base station can function as a coordinator or proxy as described below.

Any type of smart device can be controlled. Examples of smart devices that are accessories include door lock 104, garage door system 106, light fixture 108, security camera 110, and thermostat 112. In some instances, controller 102 can communicate directly with a smart device; for instance, controller 102 is shown communicating directly with door lock 104 and garage door system 106. In other instances, controller 102 can communicate via an intermediary. For instance, controller 102 is shown communicating via a wireless network access point 114 with smart devices 108, 110, 112 that are on a wireless network provided by access point 114. As noted above, in some embodiments, controller 102 can include a base station, and base station functionality can be integrated into access point 114 or into one of the accessories that is to be controlled (e.g., thermostat 112). Another type of intermediary can be coordinator 116, which, in addition to operating as a controller, can relay messages between other controllers and accessories. In some embodiments, coordinator 116 can also implement various control logic to automate or optimize interactions with accessories; examples are described below.

Various communication transports and combinations of transports can be used, and different transports can be used with different devices. For example, some wireless transports such as the Bluetooth® Classic or Bluetooth® Smart communication protocol and standards promulgated by the Bluetooth SIG (referred to herein as “Bluetooth” and “Bluetooth LE”) can support direct point-to-point communication between devices within a limited range. Other wireless transports such as a wireless network complying with Wi-Fi® networking standards and protocols promulgated by the Wi-Fi Alliance (referred to herein as a “Wi-Fi network”) can define a wireless network with a central access point that routes communications between different devices on the network. Further, while wireless communication transports are shown, wired transports can also be provided for some or all of the smart devices. For example, light bulb 108 can be connected to access point 114 by a wired connection, and controller 102 can communicate with light bulb 108 by sending messages wirelessly to access point 114, which can deliver the messages to light bulb 108 via the wired connection. As another example, coordinator 116 can be connected to access point 114 by a wired connection as shown (this connection can be wireless if desired), and controller 102 can communicate with smart devices such as light bulb 108 by sending messages to coordinator 116 via access point 114; coordinator 116 can communicate with light bulb 108, either via access point 114 or via another channel such as a Bluetooth LE channel. Other combinations of wired and wireless communication are also possible.

Further, while one controller 102 is shown, a home environment can have multiple controller devices. For example, each person who lives in the home may have his or her own portable device (or devices) that can act as a controller for some or all of smart devices 104-112. Different controller devices can be configured to communicate with different subsets of the smart devices; for example, a child's controller might be blocked from modifying settings on thermostat 112, while a parent's controller device is permitted to modify the settings. Such permissions, privileges, or authorizations can be configured and controlled.

In some embodiments, a uniform accessory protocol can facilitate communication by a controller 102 with one or more smart devices 104-112. The protocol can provide a simple and extensible framework that models a smart device as a collection of services, with each service being defined as a set of characteristics, each of which has a defined value at any given time. Various characteristics can represent various aspects of the smart device's state. A smart device's state can also be referred to as the mode of the smart device. For example, in the case of thermostat 112, characteristics can include power (on or off), current temperature, and target temperature. In some embodiments, message formats may be transport-dependent while conforming to the same smart device model.

The protocol can further define message formats for controller 102 to send command-and-control messages (requests) to accessory 112 (or other smart devices) and for accessory 112 to send response messages to controller 102. The command-and-control messages can allow controller 102 to interrogate the current state of smart device characteristics and in some instances to modify the characteristics (e.g., modifying the power characteristic can turn a smart device off or on). Accordingly, any type of smart device, regardless of function or manufacturer, can be controlled by sending appropriate messages. The format can be the same across smart devices.

The protocol can further provide notification mechanisms that allow accessory 112 (or other smart devices) to selectively notify controller 102 in the event of a state change. Multiple mechanisms can be implemented, and controller 102 can register, or subscribe, for the most appropriate notification mechanism for a given purpose.

In some embodiments, communication with a given smart devices can be limited to authorized controllers. The protocol can specify one or more mechanisms (including mechanisms referred to herein as “pair setup” and “pair add”) for establishing a “pairing” between controller 102 and a given smart device (e.g., door lock accessory 104) under circumstances that provide a high degree of confidence that the user intends for controller 102 to be able to control accessory 104. Pair setup can include an out-of-band information exchange (e.g., the user can enter a numerical or alphanumeric PIN or passcode provided by accessory 104 into an interface provided by controller 102) to establish a shared secret. This shared secret can be used to support secure exchange of “long-term” public keys between controller 102 and accessory 104, and each device can store the long-term public key received from the other, so that an established pairing can be persistent. After a pairing is established, controller 102 is considered authorized, and thereafter, controller 102 and accessory 104 can go in and out of communication as desired without losing the established pairing. When controller 102 attempts to communicate with or control accessory 104, a “pair verify” process can first be performed to verify that an established pairing exists (as would be the case, e.g., where controller 102 previously completed pair setup with accessory 104). The pair verify process can include each device demonstrating that it is in possession of a long-term private key corresponding to the long-term public key that was exchanged during pair setup and can further include establishing a new shared secret or session key to encrypt all communications during a “pair-verified” session, (also referred to herein as a verified session). During a pair-verified session, a controller that has appropriate privileges can perform a “pair add” process to establish another pairing with the smart device on behalf of another controller. Either device can end a pair-verified session at any time simply by destroying or invalidating its copy of the session key.

In some embodiments, multiple controllers can establish a pairing with the same smart device (e.g., by performing pair setup or by having a pairing added by a controller that previously performed pair setup), and the smart device can accept and respond to communications from any of its paired controllers while rejecting or ignoring communications from unpaired controllers.

In some embodiments, controllers (or their users) can be assigned various permissions or privileges in regard to the smart devices. For example, an administrator (or “admin”) privilege may be a highest level of privilege, and a controller with admin privileges may establish pairings with smart devices and control any controllable characteristic of the smart device state. In some embodiments, admin privilege may be granted to the first controller to perform pair setup with a particular smart device, and after the admin controller performs pair setup, the smart device can decline to perform pair setup with any other controllers; instead, the admin controller can grant access to other controllers (or other users) by performing pair add. In some embodiments, the admin controller can specify privileges for each added controller (including admin privileges).

It will be appreciated that home environment 100 is illustrative and that variations and modifications are possible. Embodiments described herein can be implemented in any environment where a user wishes to control one or more smart devices using a controller device, including but not limited to homes, cars or other vehicles, office buildings, campuses having multiple buildings (e.g., a university or corporate campus), etc. Any type of smart device can be controlled, including but not limited to door locks, door openers, lighting fixtures or lighting systems, switches, power outlets, cameras, environmental control systems (e.g., thermostats and HVAC systems), kitchen appliances (e.g., refrigerator, microwave, stove, dishwasher), other household appliances (e.g., clothes washer, clothes dryer, vacuum cleaner), entertainment systems (e.g., TV, stereo system), windows, window shades, security systems (e.g., alarms), sensor systems, and so on. A single controller can establish pairings with any number of smart devices and can selectively communicate with different smart devices at different times. Similarly, a single smart device can be controlled by multiple controllers with which it has established pairings. Any function of an smart device can be controlled by modeling the function as a service having one or more characteristics and allowing a controller to interact with (e.g., read, modify, receive notifications of updates to) the service and/or its characteristics. Accordingly, protocols and communication processes used in embodiments of the technology described herein can be uniformly applied in any context with one or more controllers and one or more accessories, regardless of smart device function or controller form factor or specific interfaces.

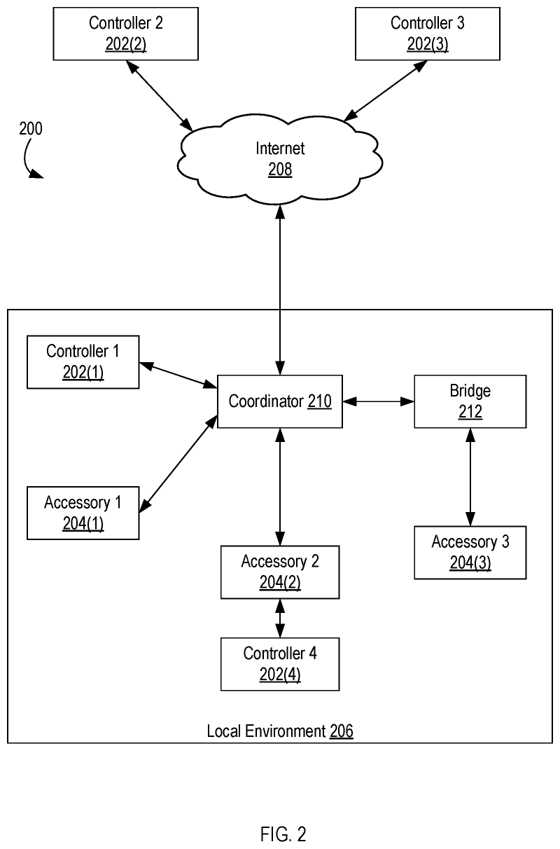

FIG. 2 shows an example network configuration 200. Configuration 200 allows controllers 202 to communicate with accessories 204 located in local environment 206 (e.g., a home environment) via a coordinator 210. Each controller 202 can be an electronic device owned and/or operated by a user who frequents environment 206 (e.g., a resident of the home or a regular visitor to the home). For example, controller 202 can be resident device (e.g., a desktop computer, tablet computer, streaming media device, smart television, smart router etc.) that typically stays within (e.g., resides in) local environment 206. Controllers 202 can each be similar to controller 102 of FIG. 1, and accessories 204 can be similar to various accessories shown in FIG. 1.

Accessories 204 can each communicate with a coordinator device (or “coordinator”) 210 that can be located with local environment 206. As used herein, a “coordinator” can be an electronic device that is capable of operating as a controller of accessories 204 as well as relaying messages from other controllers (e.g., controllers 202) to accessories 204. In some embodiments, coordinator 210 can be an “intelligent” device that can coordinate operations among multiple controllers and/or accessories and is not limited to passively relaying messages. Coordinator 210 can include any device that is capable of presenting itself as a controller to accessories 204 and that is capable of communicating securely with controllers 202. In some embodiments, coordinator 210 can present itself to accessories 204 as a controller and to controllers 202 as an accessory that provides services for communicating with other smart devices (e.g., accessories 204). In some embodiments, coordinator 210 can be a device that is expected to stay in local environment 206 and that is expected to be powered on and available for communication most or all the time. (It is to be understood that coordinator 210 can occasionally be unavailable, e.g., in connection with software or firmware upgrades, power outages, or other intermittent occurrences.) For example, coordinator 210 can be implemented in a desktop computer, a Wi-Fi or access-point unit, a dedicated smart device-control base station, a set-top box for a television or other appliance (which can implement coordinator functionality in addition to interacting with the television or other appliance), or any other electronic device as desired.

In some embodiments, coordinator 210 and accessories 204 can communicate using a local area network (LAN), such as a Wi-Fi network and/or a point-to-point communication medium such as Bluetooth LE. It is to be understood that other communication protocols can be used. In some embodiments, controllers 202, accessories 204, and coordinator 210 can support a uniform smart device protocol as described above that can be supported using both Wi-Fi and Bluetooth LE as transports.

In the example of FIG. 2, controllers 202(1) and 202(4) are currently located in local environment 206 with accessories 204 and coordinator 210. For example, controller 202(1) can be on the same LAN as accessories 204 and coordinator 210. Controllers 202(2) and 202(3) are currently located outside local environment 206 but are connected to a communication network 208 (e.g., the Internet); such controllers are said to be “remote” from accessories 204 and coordinator 210. It is to be understood that controllers 202 can be mobile devices that are sometimes within local environment 206 and sometimes outside local environment 206. Accessories 204 need not be mobile and need not be connected to communication network 208 (although they can be if desired). In some embodiments, coordinator 210 can be connected to communication network 208 and can facilitate access to accessories 204 by remote controllers 202(2) and 202(3).

In the example shown, controllers 202 can communicate with accessories 204 via coordinator 210, and coordinator 210 can be said to act as a “proxy” for accessories 204. Coordinator 210 can communicate directly with accessories 204(1) and 204(2). In the case of accessory 204(3), coordinator 210 can communicate via “bridge” 212. Bridge 212 can operate to relay commands between a controller and an accessory; in some embodiments, bridge 212 and/or coordinator 210 can also translate between different communication protocols used by coordinator 210 or controller 202 and accessory 204(3). Further, in some embodiments, bridge 212 can be implemented as a “tunnel” that can provide secure end-to-end communication between coordinator 210 and accessory 204(3).

In some implementations of network configuration 200, controllers 202 can be configured to communicate with accessories 204 via coordinator 210 whenever possible. Thus, as shown, controller 202(1), which is in local environment 206, communicates with coordinator 210 rather than directly with accessories 204, as do remotely located controllers 202(2) and 202(3). Direct communication between any of controllers 202 and accessories 204 can be limited, e.g., to situations where coordinator 210 is not available. In other embodiments, controllers 202 may communicate directly with accessories 204 whenever they happen to be in range of each other (e.g., on the same Wi-Fi network or within Bluetooth range). For instance, as shown, controller 202(4) can communicate directly with accessory 204(2).

In some embodiments, coordinator 210 can be used to coordinate access by multiple controllers 202 to multiple accessories 204. For example, rather than establishing a pairing between each controller 202 and each accessory 204, controllers 202 can each establish a pairing with coordinator 210, and coordinator 210 can establish a pairing with each accessory 204. The same pair setup and/or pair add processes used to establish a controller-accessory pairing can also be used to establish a controller-coordinator pairing, with the coordinator acting in the role of accessory. For purposes of coordinator-accessory pairing, the coordinator can assume the role of controller. Thus, coordinator 210 can present itself as an accessory when communicating with a controller (e.g., any of controllers 202) and as a controller when communicating with an accessory (e.g., accessory 204).

Coordinator 210 can facilitate operation of an accessory network including accessories 204. For example, coordinator 210 can maintain an environment model for the smart device network and can provide the model (or portions thereof) to various controllers 202; examples of an environment model are described below. Controllers 202 can operate accessories 204 by interacting with coordinator 210.

In some embodiments, coordinator 210 can manage permissions associated with the smart device network or environment model to limit access by specific controllers 202 to some or all accessories 204. In some embodiments, controllers 202 can preferentially route all requests to accessories 204 through coordinator 210, and in some embodiments, accessories 204 can be configured to communicate directly only with coordinator 210 and to ignore requests that come directly from controllers 202. This can allow coordinator 210 to enforce permissions and other restrictions on access to accessories 204.

Centralizing communication with smart device through coordinator 210 can simplify management of a controller network and/or smart device network (e.g., controllers 202 and accessories 204 in local environment 206). For example, if a new smart device is acquired, the new smart device need only establish a pairing with coordinator 210 in order to allow all controllers 202 to have access to the new smart device. Similarly, if a new controller 202 is acquired, the new controller 202 need only establish a pairing with coordinator 210 to allow the new controller to have access to all accessories 204. In an environment with multiple controllers (e.g., a family where the members each have multiple devices) and perhaps dozens of smart device, the time saving can be considerable.

It should be noted that in configuration 200, it is possible that one or more of the controllers (e.g., controller 202(1)) can be permitted to communicate with one or more smart device (e.g., accessory 204(1)) indirectly (via coordinator 210) but not directly, regardless of whether controller 202(1) is in local environment 206. This might occur, for instance, if controller 202(1) has established a pairing with coordinator 210 but not directly with accessory 204(1). In some instances, this can provide enhanced security; for instance, a smart device that has a pairing established with coordinator 210 can refuse to establish any other pairings. However, there may be cases where direct access is desirable, and establishing a direct pairing between a certain smart device, e.g., accessory 204(1) and one or more controllers 202 can be permitted. For example, suppose that accessory 204(1) is a door lock and controller 202(1) is a mobile phone. If a direct pairing between accessory 204(1) and controller 202(1) is established, a user can use controller 202(1) to lock or unlock accessory 204(1) via direct communication, thereby locking or unlocking the door. This can be useful, e.g., in the event that coordinator 210 is temporarily unavailable. In some embodiments, coordinator 210 can be used to indicate to accessory 204(1) which of controllers 202 are authorized for direct access, and accessory 204(1) can establish pairings with authorized controllers 202. In some embodiments, accessory 204(1) can be configured to accept direct communication from an authorized controller 202 only when coordinator 210 is not available. Thus, the general rule can be that all communications with accessory 204 go through coordinator 210, with exceptions made on a per-accessory and per-controller basis.

Coordinator 210 can operate as an intelligent agent for allowing controllers to operate smart device, rather than simply relaying messages. For example, coordinator 210 can establish a pairing with each of controllers 202 and a pairing with each accessory 204. When controller 202(1), for example, receives a user request to interact with a specific smart device, e.g., accessory 204(1), controller 202(1) can establish a first pair-verified session with coordinator 210 and provide its instructions for accessory 204 to coordinator 210 via the first pair-verified session. Coordinator 210 can receive the instructions, establish a second pair-verified session with accessory 204 and send appropriate control messages to accessory 204 via the second pair-verified session. In some embodiments, coordinator 210 can be privy to the content of the instructions, and in some embodiments, the messages sent to accessory 204 need not correspond to the instructions provided by controller 202(1). For example, while communicating with controller 202(1), coordinator 210 may also be in communication with another controller (e.g., controller 202(2)). Controllers 202(1) and 202(2) may each provide instructions for accessory 204 to coordinator 210. Coordinator 210 can analyze the received instructions, e.g., to detect and resolve conflicts such as where controller 202(1) instructs coordinator 210 to turn accessory 204 on while controller 202(2) instructs coordinator 210 to turn accessory 204 off. Coordinator 210 can be programmed with priority rules or other rules for resolving conflicts (e.g., “on” takes priority over “off”; instructions from a controller with admin privilege take precedence over instructions from a controller without admin privilege; etc.). Coordinator 210 can apply the priority rules to resolve any conflicts and can communicate instructions to accessory 204 based on the resolution. When a response is received from accessory 204, coordinator 210 can determine whether to send a corresponding message (or a different message) to controller 202(1) and/or to controller 202(2).

As another example, coordinator 210 can enforce permissions established for various controllers 202 and/or accessories 204. For example, when one of controllers 202 sends a request, coordinator 210 can apply decision logic to determine whether the controller 202 that sent the request has appropriate permission; if not, coordinator 210 can reject the request. The decision logic can be as simple or complex as desired; for instance, a controller belonging to a child may be limited as to which hours of the day or for how long it can operate a particular smart device (e.g., a TV) while a parent's controller can have unlimited access, or a controller associated with a guest (e.g., a babysitter) may be restricted to operating a certain subset of the smart devices. Thus, coordinator 210 is not limited to acting as a passive relay for messages between controllers and accessories but can actively intervene to resolve conflicting instructions, enforce any limitations that may exist on the privileges or permissions granted to particular controllers or users, and so on.

It will be appreciated that network configuration 200 is illustrative and that variations and modifications are possible. Any number of controllers and any number of accessories can be included in a network configuration. In some embodiments, coordinator 210 can be replaced with a proxy that relays messages between controllers and accessories without necessarily reading the content of the messages. In some embodiments, coordinator 210 can be omitted entirely. Some or all of accessories 204 may be accessible only within the local environment. Further, as described below, different controllers 202 may have different levels of permission in regard to accessing accessories 204; for instance, remote access via network 208 may be permitted for some controllers 202 but not for other controllers 202.

As noted above, coordinator 210 can be particularly useful in the context of an automated environment with a number of smart devices that can be controlled. Examples include homes, cars or other vehicles, office buildings, campuses having multiple buildings, etc. For purposes of illustration, an example of an smart device network implementation for a home will be described; those skilled in the art with access to the present disclosure will understand that similar smart device networks can be implemented in other automated environments.

In one example of an smart device network, each smart device is connected to one or more controllers, and smart device can be controlled by sending messages. This can be perfectly serviceable for small networks with just a few smart devices. However, in some instances, particularly as the number of smart devices increases, it can be helpful to establish meaningful (to a user) groups of smart devices that can be managed in a coordinated fashion. Accordingly, certain embodiments of the present technologies described herein incorporate environment models usable to coordinate control across multiple smart devices in an smart device network.

As used herein, an environment model can provide various logical groupings of the smart devices in an environment. For example, a home environment can be modeled by defining “rooms” that can represent rooms in the home (e.g., kitchen, living room, master bedroom, etc.). In some cases, a room in the model need not correspond to a room in the home; for instance, there can be a “front yard” room or an “anywhere” room (which can be used to refer to smart devices that are present in the home but whose location within the home is subject to change or has not been defined as a room). Each smart device in the home can be assigned to a room in the environment model, e.g., based on the actual physical location of the smart device. Rooms can be grouped into zones based on physical and/or logical similarities. For instance, an environment model for a two-level house might have an “upstairs” zone and a “downstairs” zone. As another example, an environment model might have a “bedrooms” zone that includes all bedrooms regardless of where they are located. The model can be as simple or complex as desired, e.g., depending on the size and complexity of the environment.

Where an environment model is defined, smart devices represented in the environment model can be controlled individually or at the level of rooms, zones, or the whole model. For instance, a user can instruct a controller or coordinator to turn on all the outside lights or to turn off all smart devices in a specific room.

Other groupings of smart devices can also be defined. For example, in some embodiments, a user can augment an environment model by grouping various smart devices into “service groups” that can include any set of smart devices the user may desire to control together, at least some of the time. A service group can include smart devices in any combination of rooms or zones, and the smart devices in a service group can be homogeneous (e.g., all upstairs lights) or heterogeneous (e.g., a light, a fan, and a TV). In some embodiments, a user can provide a single instruction to a controller to set the state of an entire service group (e.g., turn the group on or off). While not required, the use of service groups can provide another degree of flexibility in coordinating control over multiple smart devices.

In some embodiments, the environment model for a given environment can be represented as a data object (or set of data objects). The environment model can be created on a controller associated with the environment (e.g., a controller with admin privileges) and can be shared with other controllers through a synchronization operation. For instance, controllers 202 of FIG. 2 can synchronize with a “master” copy of the environment model maintained by coordinator 210 (which can receive updates from controllers 202), or cloud-based synchronization (in which the master copy is stored in a location accessible via network 208 and automatically synchronized with the controllers and coordinator(s) associated with the environment) can be used. Accordingly, all controllers and coordinators associated with a given environment can have shared access to the same environment model.

In some implementations, controllers 202 can be used to control and interact with other controllers 202 in the same way controllers 202 can be used to control and interact with accessories 204 as described herein. In some implementations, a controller 202 with a higher priority can control another controller 202.

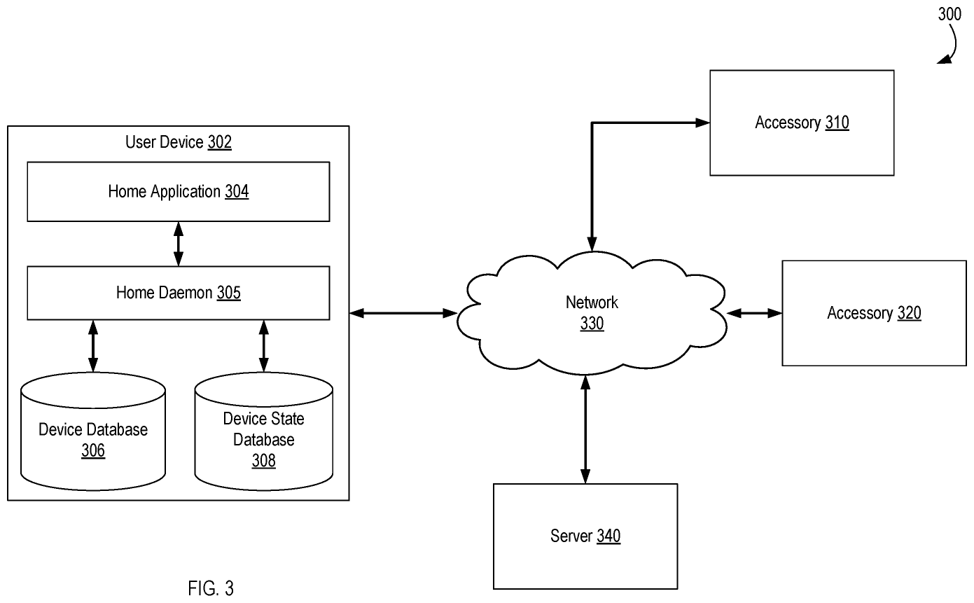

FIG. 3 is a block diagram of an example system 300 for managing smart devices. In some implementations, system 300 can include user device 302. User device 302 can, for example, correspond to one of controllers 202 (e.g., controller 202(1), controller 202(2), etc.), as described above with reference to FIG. 2. User device 302 can correspond to coordinator 210 (e.g., coordinator 116), as described above with reference to FIG. 2. For example, user device 302 can be a computing device, such as a laptop computer, tablet computer, smartphone, or wearable device (e.g., a smartwatch, smart glasses, smart clothing, etc.). User device 302 can be a computing device, such as a desktop computer, streaming media device, home media server, router, or other computing device. User device 302 can include, for example, home application 304. Home application 304 can be a standalone user application or a system application (e.g., tightly integrated with or part of the operating system) of user device 302.

In some implementations, user device 302 can include home daemon 305. For example, home daemon 305 can be a daemon or background process running on user device 302 that monitors the state of various smart devices and/or coordinates communication between smart devices and other user devices (e.g., other home applications), as described above and below. In some implementations, home daemon 305 can be configured to collect state information, configuration information, and/or feature information from various smart devices and store the device information in the appropriate databases (e.g., device database 306, device state database 308, etc.). When home application 304 requires smart device information (e.g., state information, configuration information, feature information, smart device control information, etc.) for smart devices managed by home application 304, home application 304 can request the smart device information from home daemon 305 and home daemon 305 can obtain the information from the appropriate databases (e.g., device database 306, device state database 308, etc.) as described below.

In some implementations, when user device 302 is configured as a controller (e.g., controller 202(1), controller 202(2)), user device 302 can include home application 304, home daemon 305, device database 306, and/or device state database 306. When user device 302 is configured as a coordinator (e.g., coordinator 116, coordinator 210), user device 302 may include a reduced feature set and include home daemon 305, device database 306 and/or device state database 308. As described above, as a controller, user device 302 can act as both controller and coordinator using home application 304 and home daemon 305.

Home application 304 can be configured to manage and control smart devices and smart devices states. In some implementations, smart device states can refer to modes enabled on smart devices. For example, when a user installs or configures a smart device (e.g., accessory 310, accessory 320) in the user's home, the smart device can broadcast a message (e.g., a Bluetooth signal) advertising the existence of the smart device. Home application 304 can receive the broadcast message and add the smart device to the smart devices managed by home application 304. For example, home application 304 can receive state information from individual smart devices (e.g., accessory 310, accessory 320, etc.) through network 330 (e.g., a WAN, LAN, WLAN, peer-to-peer Wi-Fi, Bluetooth, etc.) and present the state information to the user on a display of user device 302. Home application 304 can send commands (e.g., automatically and/or in response to user input) to change the current state of the individual smart devices through network 330. Thus, home application 304 can turn on and off smart lights, lock and unlock smart locks, turn on and off cameras, receive alarms from smoke detectors, and manage other smart devices and appliances throughout the user's home.

In some implementations, home application 304 can manage groups of smart devices. For example, when managing a home environment, home application 304 can group smart devices (e.g., accessory 310 and accessory 320, etc.) according to the rooms in the house where the smart devices are located, as described above. Thus, a user can interact with home application 304 to control all of the smart devices in a room as a group. For example, a single user input to home application 304 can cause home application 304 to send a command to each smart device (e.g., accessory 310, accessory 320, etc.) in an smart device group (e.g., service group) through network 330 to change the current state (e.g., turn on, turn off) of all of the smart devices assigned to a room.

In some implementations, home application 304 can group smart devices based on function, classification, or category. For example, smart devices related to external security (e.g. external lights, door locks, etc.) can be grouped together even though the smart devices are not located in the same room. In some implementations, these service groups can be generated by home application 304 in response to user input assigning smart devices to specific groups (e.g., to rooms, to functional categories, etc.). For example, the user can apply labels (e.g., room names, categories, etc.) to smart devices and home application 304 can assign the smart devices to service groups based on a set of rules for processing the labels assigned to the smart devices. In some implementations, home application 304 can automatically group smart devices according to various criteria, as described further below. In some implementations, home application 304 can group smart devices based on a user-defined grouping. In some implementations, home application 304 can group smart devices based on related uses. For example, home application 304 can learn, based on historical smart device state change data, which smart devices the user typically uses together and/or what settings or states the user specifies for the smart devices and generate service groups and/or modes based on the learned user behavior, as described in detail below.

In some implementations, system 300 can include accessory 310. For example, accessory 310 can correspond to one of accessories 204 (e.g., accessory 204(1)) of FIG. 2 or any other smart device. As described above, accessory 310 can include logic (e.g., software) and hardware (e.g., integrated circuits, radio frequency transmitters, memory, etc.) that cause accessory 310 to determine its current state and report its current state to user device 302 through network 330. Accessory 310 can include logic and hardware that cause accessory 310 to receive commands from user device 302 through network 330 that cause accessory 310 to change its current state (e.g., turn on/off, adjust volume, change speed, etc.). For example, accessory 310 can include lights, locks, doorbells, appliances, smoke detectors, carbon monoxide detectors, motion detectors, blinds, garage door openers, and/or other electrical devices that might be in a home, workplace, or other environment.

In some implementations, system 300 can include accessory 320. For example, accessory 310 can correspond to one of accessories 204 (e.g., accessory 204(2)) of FIG. 2. For example, accessory 320 can include the same or similar features as accessory 310. Accessory 320 can, for example, be the same type of device as accessory 310. Accessory 320 can be a different type of device (e.g., a fan vs. a light) and have different features (e.g., fan speed vs. light color) than accessory 310. However, both accessory 310 and accessory 320 can be smart accessories that can communicate with and be managed by home application 304.

In some implementations, user device 302 can include device database 306. For example, device database 306 can include smart device configuration information for smart devices (e.g., accessory 310, accessory 320) managed by user device 302. Home application 304 and/or home daemon 305 can, for example, obtain smart device configuration information (e.g., features, APIs, controls, commands, etc.) from accessory 310 when home application 304 and/or home daemon 305 connects to accessory 310 through network 330. For example, accessory 310 can send its configuration information to home application 304 upon establishing a connection to home application 304 and/or home daemon 305 through network 330. Accessory 310 can send its configuration information to home application 304 and/or home daemon 305 in response to a request for configuration information from home application 304 and/or home daemon 305.

In some implementations, home application 304 and/or home daemon 305 can obtain smart device configuration information from a network service (e.g., server 340) that has configuration information for accessory 310. For example, when home application 304 and/or home daemon 305 connects to accessory 310, home application 304 and/or home daemon 305 can receive a smart device identifier (e.g., make, model, serial number, etc.) from accessory 310. Home application 304 and/or home daemon 305 can send the smart device identifier to server 340 in a request for smart device configuration information. Server 340 (e.g., a server for the smart device vendor) can obtain the configuration information associated with accessory 310 (e.g., from the vendor's database) based on the smart device identifier received from home application 304 and/or home daemon 305. Server 340 can send the configuration information for the identified smart device to home application 304 and/or home daemon 305 on user device 302 through network 330. Home application 304 and/or home daemon 305 can store the smart device configuration information in device database 306.

### Monitoring Smart Device States

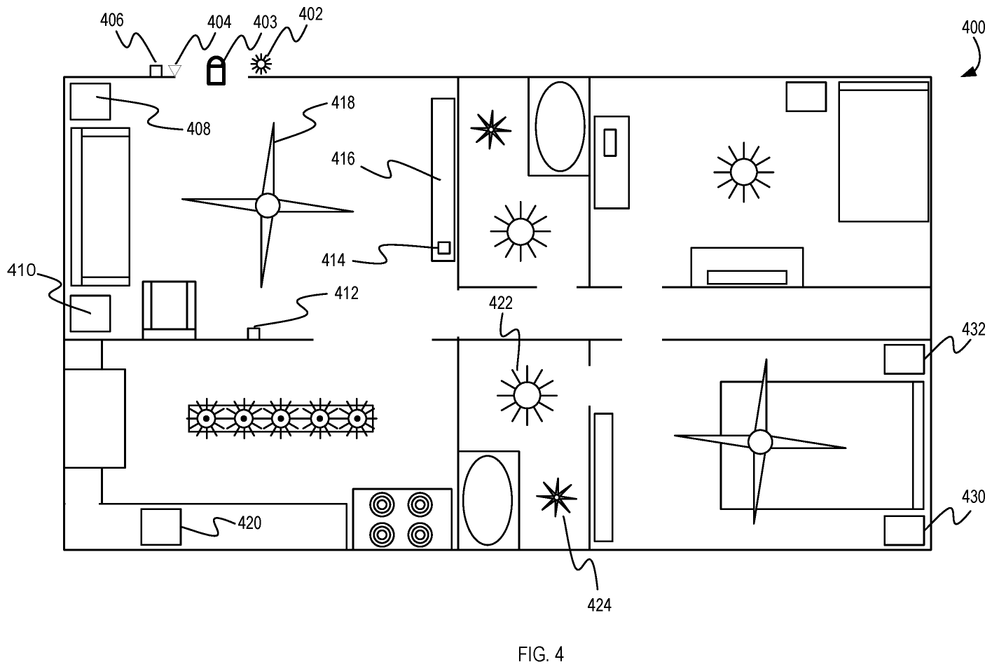

FIG. 4 is an illustration of an example home environment 400 having various smart devices 402-432. While the description of the technologies described herein are described with reference to a home or residence, a person of ordinary skill in the art will understand that the features, processes, algorithms, and mechanisms implemented by these technologies can be easily applied to other contexts such as an office, a warehouse, a garage, or other building.

In some implementations, home environment 400 can be configured with smart devices 402-432. For example, smart devices 402-432 can correspond to accessories 310 and/or 320 of FIG. 3 and other smart devices. Smart devices 402-432 can be managed and/or controlled by home application 304 and/or home daemon 305 on user device 302, as described herein.

In an example scenario (e.g., scenario ‘A’), at the front entrance (e.g., front door) of home environment 400, the owner (i.e., the user of user device 302) of home environment 400 has installed an external light 402, an external camera 404, and an external doorbell 406. When a visitor rings doorbell 406, doorbell 406 can send a status message to home application 304 on user device 302 indicating that someone manipulated (e.g., pressed a button) doorbell 406 to cause doorbell 406 to ring. In response to receiving the message, home application 304 can present a notification on the display of user device 302 notifying the user that doorbell 406 has been rung. The user can then provide input to home application 304 to turn on external light 402 and camera 404 so that the user can view the person at the door using a video feed from camera 304 presented on the display of user device 302. The user may unlock the door using door lock 403 when the user knows the visitor and wants the visitor to enter home environment 400.

In another example scenario (e.g., scenario ‘13’), the living room of home environment 400 can include lamp 408 and lamp 410. For example, lamp 408 (e.g., a light bulb, light fixture, lamp, etc.) can be an accessory (e.g., accessory 310) that has various features. Lamp 408 may, for example, simply turn on and off like a normal light. Lamp 408 may be able to illuminate different colors. Lamp 408 may be dimmable such that lamp 408 can illuminate at different brightness levels. Lamp 410, for example, can have similar or different features than lamp 408. For example, lamp 408 may only be able to turn on and off, while lamp 410 might have a dimmer and color selection features. When the user enters the living room to watch television (e.g., smart television 416 and/or streaming media device 414), read a book, or play a game, the user can turn on (e.g., when watching television) or off (e.g., when reading or playing a game) lamps 408 and 410. The user can turn on and off lamps 408 and lamp 410 using home application 304 or manually by interacting with each lamp individually.

As another example scenario (e.g., scenario ‘C’), the living room of home environment 400 can include air conditioner controller 412 (e.g., a smart thermostat), streaming media device 414, smart television 416, and/or smart fan 418. When the user watches television in the living room, the user may turn on smart television 416, streaming media device 414, fan 418, and turn on the home air conditioner using controller 412 to make the room nice and cool for watching television. The user can turn on these smart devices manually using switches on the smart devices and/or typical remote controls. The user can turn on these smart devices using home application 304 on user device 302. When the user is finished watching television, the user can turn off these smart devices manually using switches on the smart devices and/or typical remote controls. The user can turn off these smart devices using home application 304 on user device 302.

As another example scenario (e.g., scenario ‘D’), in a bedroom of home environment 400 the user may have installed smart lamps 432 and 434 next to the user's bed. The user's morning routine might be that the user turns on lamp 432 and/or lamp 434 and goes to the kitchen and turns on smart coffee maker 420 before going to the bathroom and turning on smart light 422 and smart fan 424 before taking a shower. The user can turn on each of these smart devices manually and individually by interacting physically with each device. The user can turn on each of these smart devices using home application 304 on user device 302.

When the user interacts, manipulates, or changes the state of the smart devices (e.g., as described in the scenarios above), each smart device can report a state change event that identifies its new state (e.g., now current state) to home application 304 and/or home daemon 305 on user device 302. Home application 304 and/or home daemon 305 can store the state change event information (e.g., smart device state information) received from the smart devices in device state database 308. For example, device state database 308 can store for each state change event an smart device identifier, a timestamp indicating when the event occurred, and/or the new state for the smart device. Thus, device state database 308 can store a history of smart device state changes over time.

In some implementations, smart devices (e.g., accessory 310) can report other state information to home application 304 and/or home daemon 305. For example, accessory 310 can send error state information to home application 304 and/or home daemon 305. For example, accessory 310 can determine a problem with the power supply (e.g., battery level is low, external power disconnected, etc.) for accessory 310 and report the power supply problem to home application 304 and/or home daemon 305. Accessory 310 can determine a problem with the configuration of accessory 310 (e.g., the firmware or software is out of date) and report the configuration problem to home application 304 and/or home daemon 305. Accessory 310 can determine a security problem (e.g., an unauthorized user attempted to access the smart device) and report the security problem to home application 304 and/or home daemon 305. As described above, when home application 304 and/or home daemon 305 receives information describing a state change event, home application 304 can store the state change event data in device state database 308.

### Description of Modes

A mode can be activated on smart devices which enables a set of settings on the smart device. In some implementations, an activated mode on a smart device can be referred to as a state of the smart device. The settings that can be set through modes can be related to any type of functionality that can be performed by the smart devices. For example, settings can be related to audio notifications such as a ringtone or chirp/sound related to an app or message. In another example, the settings can be related to a visual notification such as a reminder, pop-up message, or lingering message. The settings can also be related to the activation of certain features, settings, or applications on the smart device.

A user may enable modes on their smart devices for common scenarios they may find themselves in. For example, a mode can be a “work” mode. The work mode on a smartphone can deactivate notifications from certain applications such as deactivating notifications from an email application for personal email. Another mode can have a different set of settings. For example, a “deep work” mode. The deep work mode can deactivate almost all notifications except calls and emails from particular contacts such as a direct supervisor. Modes can be customized by users to include settings for any functionalities or features of the smart devices. Smart devices can also make suggestions regarding particular settings of a mode over time as it notices how the user activates certain settings under certain conditions.

Modes can sync across multiple smart devices. For example, a user may enter the work mode via an auditory cue to their smart speaker. In the work mode, the smart speaker can lower its volume, play the user's “work” music, and/or disable certain features such as an auditory cue that someone has rung the doorbell. Enabling the work mode on the smart speaker can cause the user's laptop to also enter a work mode. Although the same mode can be activated on multiple devices, each device can have different settings regarding the mode. For example, a smart phone in work mode may restrict personal email notifications while the laptop in work mode may not restrict personal email notifications. Settings associated with a mode that are set across multiple smart devices can be specific to the type of smart device (for example, laptops, tablets, smart speakers, smart routers, etc.) such that settings can be synced across all smart devices of that type. Settings associated with a mode that are set across multiple smart devices can be specific to the category of smart device (for example, controller, accessory, mobile device, resident device) such that settings can be synced across all smart devices of that category. Settings can also be specific to particular devices, even if the devices are the same type. For example, a first laptop that enables a mode can be set to a particular set of settings while a second laptop that enables the same mode can be set to a second particular set of settings.

Modes on smart devices can be enabled through triggering actions in multiple ways. When a mode is enabled through triggering actions, the mode can be referred to as triggered. A user may manually trigger a mode. For example, the user can trigger a mode through interacting with a GUI. In another example, the user can trigger a mode through an auditory cue. A user can trigger a mode through a triggering action tied to a particular time or date, whether periodically or one-time. A user may also use a location as a trigger for a mode such that when a smart device enters within a proximity of a location or within a geofence, a triggering action enables the mode. Signals from sources external to the smart device can also be used as a trigger for a mode. For example, an smart device can receive a signal from a sensor that determines that a condition is met such that a signal is sent to the smart device to trigger a mode.

### Enabling Modes on Multiple Devices

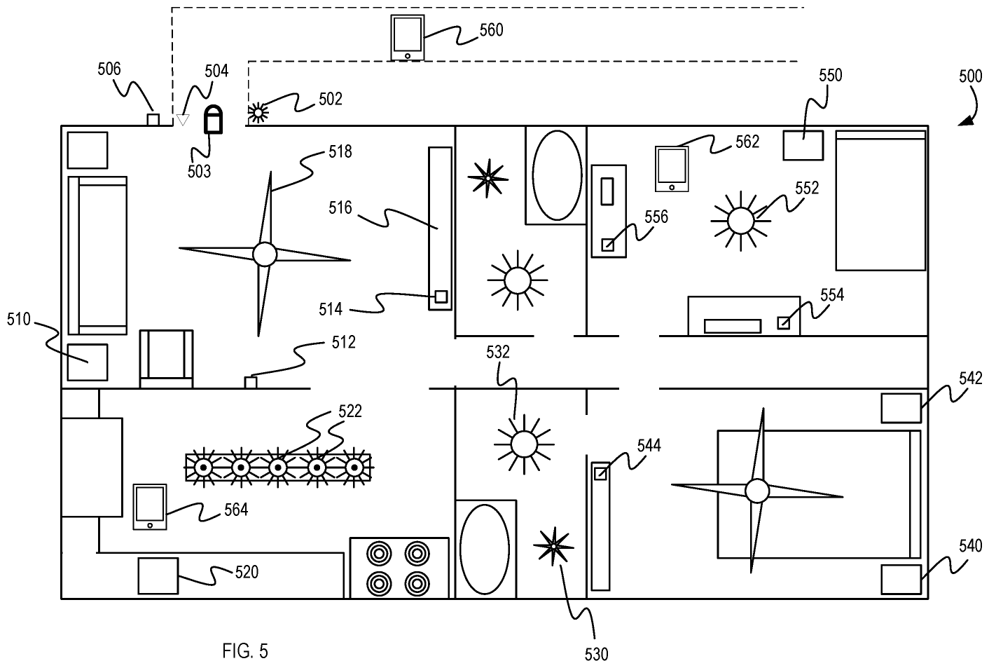

FIG. 5 is an illustration of an example home environment 500 having various smart devices 502-556. While the description of the technologies described herein are described with reference to a home or residence, a person of ordinary skill in the art will understand that the features, processes, algorithms, and mechanisms implemented by these technologies can be easily applied to other contexts such as an office, a warehouse, a garage, or other building.

In some implementations, home environment 500 can be configured with smart devices 502-556. For example, smart devices 502-556 can correspond to accessories 310 and/or 320 of FIG. 3 and other smart devices. Smart devices 502-556 can be managed and/or controlled by home application 304 and/or home daemon 305 on user device 302, as described herein.

In some implementations, home environment 500 can interact with mobile devices 560, 562, 564 which are authorized to control the smart devices 502-556 via modes or other means associated with the mobile devices 560, 562, 564.

### Modes Affecting Smart Devices within a Proximity

The mode of an authorized controller can be configured to activate the same mode in nearby smart devices within a proximity. For example, the mode of mobile device 662, if authorized, can activate the same mode for smart devices within a proximity such as in the same room. Thus, a mode on mobile device 662 can activate the same mode for lamp 550, fan 552, a desk lamp 554, and smart speaker 556 while not activating the same mode for devices in other rooms such as smart media player 544.

Although a mode on any authorized controller can activate the same mode in nearby smart devices, users may want to activate modes on their mobile devices because the user has their mobile device with them wherever they go. As a user moves between rooms or commutes between work/school and home, the mode activated on their mobile device can enable the same mode in nearby smart devices. In this way, a mode can be reflective of the state or mood of the user and affect the environment and/or smart devices around them. Automatically synchronizing the mode of an authorized mobile device to enable the same mode for nearby smart devices can make home automation more seamless. In this way, modes can be more reactive to a current state of the user.

When a controller with a particular mode activated comes within a proximity of smart devices, the same mode can be enabled for nearby smart devices. For example, when a user with a mobile device 560 (one example of a controller) in a “quiet time” mode arrives at their home, the smart devices 502-556 (or a subset) of the home can enable the same quiet time mode of the mobile device. As described herein, although each device can be in the same quiet time mode, each device can have different settings which can be device-specific, device category-specific, device type-specific, service group-specific or any other configuration. In some implementations, the smart devices of different rooms can change mode as the controller (and accompanying user) move throughout the rooms of the house. For example, the mode of mobile device 564 may affect lamp 520 and lights 522 when in that room, but as the mobile device 564 (and accompanying user) move into the nearby room lamp 510, air condition controller 512, streaming media device 514, smart television 516, and fan 518 can enable the same mode as the mode activated on mobile device 564 while lamp 520 and lights 522 may no longer enable the same mode as the mode activated on mobile device 564. In some implementations, as a controller with a particular mode activated moves outside of a proximity of smart devices, those smart devices can return to their prior mode or set of settings, or to a default mode or set of settings.

When a controller in a first mode (for example, a “normal” mode with standard settings) enters a second mode while within a proximity of smart devices, the second mode can be enabled on nearby smart devices. For example, a user can be in their home office with smart devices 550-556 nearby with their mobile device 562 in a “normal” mode. The user can then enable a “home office” mode on their mobile device 562, such that fan 552 nearby can activate the same mode and desk lamp 554 at the home office desk can activate the same mode as described herein.

The mode of a controller can affect the mode of smart devices within a certain proximity. Proximity can be determined by distance, signal strength, being within a geofence, and the like. In some implementations, the mode of any controller in house environment 500 (for example, smart speaker 556, smart media player 544, smart TV 516, or mobile devices 560, 562, and 564) can enable the same mode on all smart devices 502-556 in a house (or any building) when the controller is within the geofence of the house. In some implementations, the mode of a controller can enable the same mode on smart devices in a room or portion of a house based on a geofence for the room or portion of the house. In some implementations, sensors (on a smart device or separate from a smart device) can be used to determine whether a user and/or a controller have entered/exited rooms or is located in a particular room.

In some implementations, the proximity of a smart device to the controller can be determined by a distance or a proxy used to estimate or calculate the distance between the controller and a smart device. For example, the mode of a controller (for example, a resident device like a smart media player) can be configured to affect the mode of every smart device within a certain distance such as 20 feet. Proxies for distance can include signal strength or a calculation of distance based on external sensors monitoring the location of the controller and/or user holding the controller (for example, a mobile device). External sensors can include cameras, proximity sensors, and the like. For example, an internal camera can calculate the location of a person holding a controller or a controller within the field of view of the camera and then extrapolate the distance of the person or mobile device to particular smart devices. In some implementations, the mode of a controller can enable the same mode on smart devices within a distance of the controller such that smart devices in multiple rooms can enable the same mode as the controller. For example, a user can activate a “dinner date” mode on their smart media player in the dining room such that the “dinner date” mode is activated on devices such as the phones within the dining room don't ring except for preselected contacts, the lights in the living room, dining room, and kitchen all dim, and relaxing music begins to play in the living room.

Proximity can also be measured from another device to a smart device. In some implementations, the mode of a controller can be configured to enable a mode on smart devices within a proximity of a coordinator (for example, coordinator 210 of FIG. 2). For example, the mode of a controller can enable the same mode on a fan and/or a lamp within a proximity of a coordinator, even if the fan and lamp are not within a proximity of the controller. In some implementations, the mode of a controller can be configured to enable the same mode on smart devices that are controlled or coordinated by a coordinator (for example, the coordinator 210 of FIG. 2 which can be hosted on any of smart devices 502-556). In some implementations, the mode of a controller can be configured to enable a mode for a particular service group of smart devices regardless of proximity.

A mode activated on a controller can enable the same mode on different types of smart devices within different proximities. For example, a mobile device 562 may affect lamps, fans, and thermostats within the room it is located (having the proximity set to a room) while the same mobile device 562 may also affect the doorbell 506, external camera 504, external light 502 and lock 503 (having a house-wide proximity) without affecting fan 518 and lamp 510 (that are in another room).

In order for the mode of a controller to enable the same mode on other smart devices, the controller can be authorized. For example, a first parent user may enable the mode of their smartphone to enable the same mode on smart devices in the home while not enabling the mode of a child's smartphone to enable the same mode on smart devices in the home. Similarly, the mode of guests' controllers can be not authorized to enable the same mode on smart devices in the user's home.

Multiple controllers can be authorized to enable modes on smart devices within their respective proximities. In some implementations, a priority can be assigned to each controller such that a higher priority controller's mode enables the higher priority controller's mode on smart devices over a lower priority controller's mode. For example, mobile device 562 may have a higher priority than mobile device 564 such that when the mobile devices 562, 564 are in different modes, the mode of mobile device 662 takes priority and enables the same mode on nearby smart devices. In some implementations, a mode enabled on a first controller can only be enabled on second controller within a proximity of the first controller if the first controller has a higher priority than the second controller.

In some implementations, different modes can have different priorities such that if there are conflicting modes activated on controllers within a proximity, the mode with a higher priority takes precedent and is enabled on nearby smart devices. In some implementations, a mode enabled on a first controller can only be enabled on second controller within a proximity of the first controller if the mode of the first controller has a higher priority than the mode of the second controller.

In some implementations, when a controller enters a mode while within a proximity of other smart devices, the mode has a corresponding set of settings for nearby smart devices. When the mode is enabled on nearby smart devices by the mode of the controller, the smart devices know what settings should be activated by that mode. In some implementations, when a controller enters a mode while within a proximity of smart devices, some or all nearby smart devices do not have a predetermined corresponding set of settings for that mode. Instead, a set of settings can generated with particular characteristics for nearby smart devices based on some or all of the settings of the mode on similar devices or the controller. In some implementations, the generated set of settings for the mode can be saved as a suggestions for those particular smart devices. In some implementations, when a controller enters a particular mode within a proximity of smart devices, a set of settings can be generated for review by the user and presented to the user on the controller for modification and/or immediate implementation as the mode for those particular smart devices.

There a variety of ways in which the mode on a controller can be configured to enable the same mode on smart devices. An API can be used by the controller that sends the mode to smart devices when the controller connects to a network or comes within a proximity of smart devices. In some implementations, when a controller comes within a proximity of smart devices, the controller determines its mode and makes API calls to the smart devices based at least in part on the mode to enable the same mode on the smart devices.

### App-Based Triggers

Another way to activate modes on smart devices is based on app-based triggers, which can also be triggering actions. Apps on devices can generate triggers and/or events that can be shared with smart devices within a proximity of the device with the app. The triggers/events from apps can create API calls to smart devices within the proximity or can be sent to a controller or coordinator which generates API calls to smart devices within the proximity.

When a particular event occurs in an application, the device can send information to nearby smart devices or controllers to enable a mode or set of settings. For example, a user may open their yoga application or start playing a yoga workout video on their smartphone. The opening of the yoga application or playing a yoga workout video can trigger a “yoga” mode on the smartphone. The yoga mode on the smartphone can then enable the same yoga mode on nearby smart devices. For example, relaxing music can play on a smart speaker, the smart thermostat for the room can increase the temperature, and smart blinds can shut. Similarly, tablets and laptops in the room can temporarily disable auditory and visual notifications.

The app can interact with an API to activate a mode for nearby smart devices. In another example, a calendar app on a mobile device may have certain meetings or events that enable a “meeting” mode for nearby smart devices. When a particular (or any) work meeting comes up on the calendar while the mobile device is in a home office, a light for use during video calls can come on. Additionally, a speaker in the room which is configured to make a doorbell chime when the doorbell rings may make a much quieter doorbell chime under such circumstances.

In some implementations, the app can receive information that causes the app to send a trigger to change the mode of a controller. The controller can then trigger the change of the mode of smart devices within proximity. For example, a user may have a biking exercise machine that corresponds to an app. The user can start a workout on their biking exercise machine which sends this information to the app such that the app sends a trigger to a controller (for example, the smartphone running the app) to enter a “biking” mode. The biking mode on the controller can be enabled on nearby smart devices such that workout music preselected by the user can play on a smart media player, the smart thermostat for the room can decrease the temperature by turning on the air conditioner, or smart blinds and windows can open.

### Broadcasting Modes to Other Smart Devices

Modes can also be broadcasting by smart devices (for example, controllers) to affect other smart devices (for example, a guest's smart phone or smart media player) as they enter a proximity. For example, as a mobile device enters proximity of the accessories, the mobile device can receive a broadcast indicating the mode of the smart devices. The broadcast can prompt an adjustment of settings on the mobile device or trigger a change of settings on the mobile device. For example, mobile device 560 can be arriving at the home environment 500 such that a mode for smart devices in home environment 500 are broadcasted to mobile device 560. In some implementations, the smart devices are able to determine that the smart device entering a proximity is an unknown device or a device that does not belong to the network of smart devices.

Broadcasting of modes can be a one-directional broadcast (for example, a beacon) such that the smart devices broadcasting the mode do not receive information from the receiving smart devices. The broadcast can happen periodically, for example once every twenty seconds. In some implementations, the receiving smart device doesn't connect with any broadcasting smart device but rather just receives information from the broadcasting smart devices. In some implementations, broadcasting of modes can include asking receiving devices for certain information regarding the type of the receiving device and other basic, non-personal information for communication purposes.

Any smart device can be used to broadcast modes to nearby smart devices. In some implementations, controllers, such as resident devices and mobile devices, broadcast modes. For example, a plumber may come to work on the plumbing at a home with smart devices. The plumber can enter the home and the plumber's mobile device can receive an indication regarding the mode of smart devices in the home, for example, that the baby is sleeping. The indication can ask or require the plumber to set certain settings on their phone in compliance with the mode of the smart devices in the home such as silencing ringtones.

As noted above, the smart devices can broadcast modes to other smart devices that are within a certain proximity. As described herein, proximity can be determined by distance, a proxy for distance, or within a geofence, or by the like. Proximity for the broadcast can be defined as described herein for enabling modes on smart devices within a proximity. The broadcast modes can be sent only to mobile devices that come within the geofence of a building. For example, the mode is only broadcast to mobile device 560 once the mobile device has come within a geofence of the home environment 500.

Broadcasting of modes can be limited to modes initially enabled by particular controllers. For example, smart devices may not broadcast a mode that was initially enabled on a smart phone 564 while broadcasting a mode that was initially enabled on smart media player 544. In some implementations, only certain controllers are authorized to enable modes that are broadcasted. In this way, modes can be not broadcasted to smart devices entering a proximity.

Broadcasting of modes can be limited to particular modes. A user may set certain modes to be broadcasted to affect smart devices coming within a proximity. For example, when holding a special solemn event at home, the environment may be somber enough that the user would like to broadcast a mode indicative of the somber occasion to mobile devices of guests as they come to their home. In contrast, a mode could not be broadcasted such that only known smart devices, smart devices on the network, or particular smart devices enable the mode.

Broadcasting of modes can be controlled to only affect certain smart devices. In some implementations, smart devices only broadcast modes to unfamiliar smart devices. For example, smart devices can be configured to not broadcast modes to smart devices corresponding to members of a household or to a specific list of smart devices. In some implementations, smart devices only broadcast modes to particular smart devices. For example, grandparents could be frequent guests at a home and their mobile devices can be registered to enable a broadcasted mode once the mobile devices are within proximity. In some implementations, smart devices can broadcast modes set by high priority mobile devices. For example, a parent user with a high priority mobile device can set a mode related to a sleeping baby. Devices that enable that mode can broadcast the mode to other smart devices in the household, for example the mobile devices of teenage children.

Broadcasted modes can be mandatory such that a receiving smart device's settings are automatically changed when a receiving smart device comes within a proximity of broadcasting smart devices. For example, a house of worship can setup a broadcasted mode that causes smart devices that enter a proximity to lower their volume or disable auditory notifications. In some implementations, mandatory broadcasted modes can be accompanied by a notification on the receiving smart device that the smart device has enabled a mandatory broadcasted mode. In another example, mandatory broadcasted modes can be implemented through device management platforms. In some implementations, the broadcasted modes are merely suggestions.

When a mode is broadcasted, receiving smart devices receive mode information regarding the broadcasted mode via the broadcast. Mode information can include information regarding the mode such as the name of the mode, the intent of the mode, the circumstances surrounding the mode, and how the receiving device can activate settings that match the mode. Mode information can include a description of the mode. For example, mode information can indicate that the mode corresponds to a sleeping baby. The mode information can prompt the user to enable certain settings on their smart device. In some implementations, the mode information can describe example settings that a user can set on their smart device to correspond with the mode. For example, the mode information can suggest that the user set their mobile device to silent.

Mode information can include many other types of information regarding the mode being broadcasted. The mode information can be a series of instructions on what settings to set to match the broadcasted mode. The mode information can cause a message or notification to appear on the receiving smart device. In some implementations, the mode information can cause a pop-up notification. In some implementations, the mode information can cause a message to appear to be (or actually be) communicated through a communication platform (for example, an internet messaging application or a text message sent through a phone service).

Mode information can include a time or duration parameter. The time or duration parameter can indicate a time when the mode will be disabled on smart devices or a time period after which the mode will be disabled on smart devices will end. This time or duration parameter can enable a receiving smart device to automatically revert to its previous mode and/or settings prior to receiving the mode information and/or broadcasted mode after the duration has elapsed. In some implementations, the receiving smart device can present a notification or message that indicates the mode information's time or duration parameter has elapsed. In some implementations, the elapsed notification can include the instructions that were issued or settings that were changed based on the broadcasted mode information. In some implementations, the elapsed notification can include commands to return the receiving smart device to its former set of settings prior to receiving the mode information.

Mode information can also include a location parameter. The location parameter can indicate or mandate that as long as the receiving smart device is within a certain proximity (distance, geofence, etc. as proximity as described herein) the broadcasted mode can or will be enabled.

Mode information can also be different based on the receiving smart device. For example, mode information can be different for certain guest devices or unknown guest devices. Smart devices can be identified through device specific information such as a MAC address.

The mode information can also be a series of instructions on how to implement certain settings on the device. For example, the mode information can tell the user to set their mobile device to airplane mode and/or how to set their mobile device to airplane mode. The mode information can be device and/or operating system-specific based on the smart device and/or its operating system. The broadcasting smart devices can determine the receiving device and/or its operating system and then generate mode information based on the mode and the receiving device. In some implementations, the broadcasting smart devices send mode information in a standardized format which the receiving smart device can then interpret to present instructions that are particular to the type and operating system of the receiving smart device. In some implementations, the mode information can be implemented in a format (for example JSON), that can be sent to a receiving smart device wherein the receiving smart device can interpret the mode information and its format to present a notification to the user on the receiving smart device.

The mode information can be sent through a variety of channels. In some implementations, the mode information can be sent to mobile devices through a WiFi or local network. In some implementations, the mode information can be sent through Bluetooth or some other shortrange wireless signal. In some implementations, the indication can be sent over a larger network such that the receiving smart device receives the mode information through the internet, a cell network, or equivalent. In some implementations, the mode information can be sent through a private network or communication channel (for example, IDS or SharePlay).

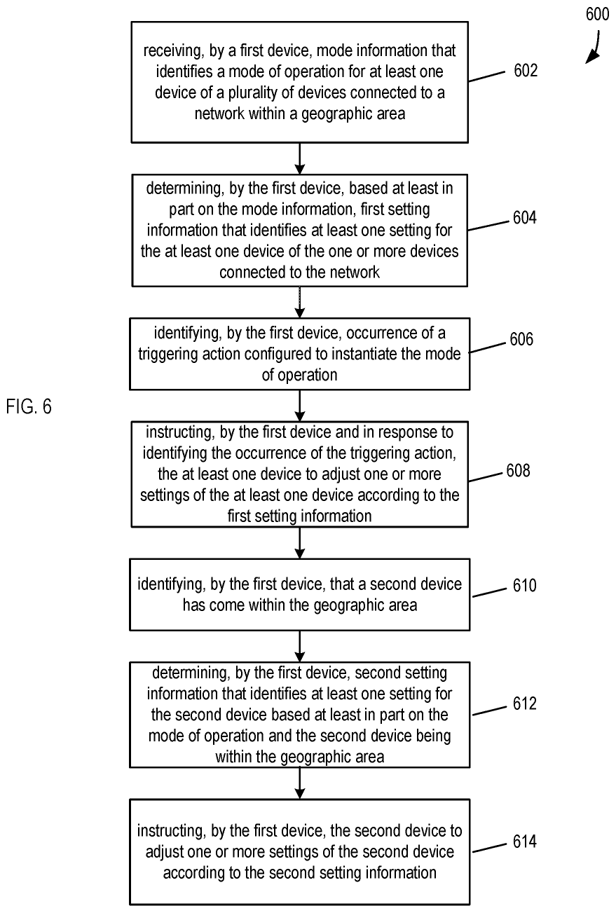

FIG. 6 illustrates an example method 600 for broadcasting a mode to smart devices as described herein. Example method 600 can be implemented by any one or combination of: an accessory (such as accessory 204(1) of FIG. 2), a controller (such as controller 202(1) of FIG. 2), or a coordinator (such as coordinator 210 of FIG. 2).

At block 602, a first device (for example, a controller 202 of FIG. 2) can receive mode information that identifies a mode of operation for at least one device (for example, a smart device) of a plurality of devices connected to a network within a geographic area.

At block 604, the first device can determine based at least in part on the mode information, first setting information that identifies at least one setting for the at least one device (for example, a smart device such as a mobile device, resident device, or an accessory) of the one or more devices connected to the network.

At block 606, the first device can identify occurrence of a triggering action configured to instantiate the mode of operation.

At block 608, the first device can instruct, in response to identifying the occurrence of the triggering action, the at least one device to adjust one or more settings of the at least one device according to the first setting information.

At block 610, the first device can identify that a second device (for example, a smart device such as a mobile device, resident device, or an accessory) has come within the geographic area.

At block 612, the first device can determine second setting information that identifies at least one setting for the second device based at least in part on the mode of operation and the second device being within the geographic area.

At block 614, the first device can instruct the second device to adjust one or more settings of the second device according to the second setting information.

### Example System Architectures

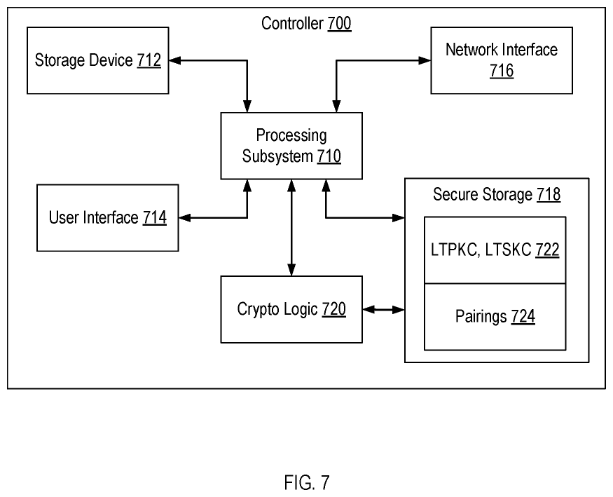

FIG. 7 shows a simplified block diagram of an example system architecture for controller 700. Controller 700 can implement any or all of the controller functions, behaviors, and capabilities described herein, as well as other functions, behaviors, and capabilities not expressly described. Controller 700 can include processing subsystem 710, storage device 712, user interface 714, communication interface 716, secure storage module 718, and cryptographic logic module 720. Controller 700 can also include other components (not explicitly shown) such as a battery, power controllers, and other components operable to provide various enhanced capabilities. In various embodiments, controller 700 can be implemented in a desktop computer, laptop computer, tablet computer, smart phone, other mobile phone, wearable computing device, or other systems having any desired form factor. Further, as noted above, controller 700 can be implemented partly in a base station and partly in a mobile unit that communicates with the base station and provides a user interface.

Storage device 712 can be implemented, e.g., using disk, flash memory, or any other non-transitory storage medium, or a combination of media, and can include volatile and/or non-volatile media. In some embodiments, storage device 712 can store one or more application and/or operating system programs to be executed by processing subsystem 710, including programs to implement various operations described above as being performed by a controller. For example, storage device 712 can store a uniform controller application that can read an accessory description record and generate a graphical user interface for controlling the accessory based on information therein. In some embodiments, portions (or all) of the controller functionality described herein can be implemented in operating system programs rather than applications. In some embodiments, storage device 712 can also store apps designed for specific accessories or specific categories of accessories (e.g., an IP camera app to manage an IP camera accessory or a security app to interact with door lock accessories). Storage device 712 can also store other data produced or used by controller 700 in the course of its operations, including trigger data objects and/or other data pertaining to an environment model.

User interface 714 can include input devices such as a touch pad, touch screen, scroll wheel, click wheel, dial, button, switch, keypad, microphone, or the like, as well as output devices such as a video screen, indicator lights, speakers, headphone jacks, or the like, together with supporting electronics (e.g., digital-to-analog or analog-to-digital converters, signal processors, or the like). A user can operate input devices of user interface 714 to invoke the functionality of controller 700 and can view and/or hear output from controller 700 via output devices of user interface 714.

Processing subsystem 710 can be implemented as one or more integrated circuits, e.g., one or more single-core or multi-core microprocessors or microcontrollers, examples of which are known in the art. In operation, processing system 710 can control the operation of controller 700. In various embodiments, processing subsystem 710 can execute a variety of programs in response to program code and can maintain multiple concurrently executing programs or processes. At any given time, some or all of the program code to be executed can be resident in processing subsystem 710 and/or in storage media such as storage device 712.

Through suitable programming, processing subsystem 710 can provide various functionality for controller 700. For example, in some embodiments, processing subsystem 710 can implement various processes (or portions thereof) described above as being implemented by a controller. Processing subsystem 710 can also execute other programs to control other functions of controller 700, including application programs that may be stored in storage device 712. In some embodiments, these application programs may interact with an accessory, e.g., by generating messages to be sent to the accessory and/or receiving responses from the accessory. Such interactions can be facilitated by an accessory management daemon and/or other operating system processes, e.g., as described above.

Communication interface 716 can provide voice and/or data communication capability for controller 700. In some embodiments communication interface 716 can include radio frequency (RF) transceiver components for accessing wireless voice and/or data networks (e.g., using cellular telephone technology, data network technology such as 3G, 4G/LTE, Wi-Fi, other IEEE 802.11 family standards, or other mobile communication technologies, or any combination thereof), components for short-range wireless communication (e.g., using Bluetooth and/or Bluetooth LE standards, NFC, etc.), and/or other components. In some embodiments communication interface 716 can provide wired network connectivity (e.g., Ethernet) in addition to or instead of a wireless interface. Communication interface 716 can be implemented using a combination of hardware (e.g., driver circuits, antennas, modulators/demodulators, encoders/decoders, and other analog and/or digital signal processing circuits) and software components. In some embodiments, communication interface 716 can support multiple communication channels concurrently or at different times, using the same transport or different transports.

Secure storage module 718 can be an integrated circuit or the like that can securely store cryptographic information for controller 700. Examples of information that can be stored within secure storage module 718 include the controller's long-term public and secret keys 722 (LTPKC, LTSKC as described above), and a list of paired accessories 724 (e.g., a lookup table that maps accessory ID to accessory long-term public key LTPKA for accessories that have completed a pair setup or pair add process as described above).

In some embodiments, cryptographic operations can be implemented in a cryptographic logic module 720 that communicates with secure storage module 718. Physically, cryptographic logic module 720 can be implemented in the same integrated circuit with secure storage module 718 or a different integrated circuit (e.g., a processor in processing subsystem 710) as desired. Cryptographic logic module 720 can include various logic circuits (fixed or programmable as desired) that implement or support cryptographic operations of controller 700, including any or all cryptographic operations described above. Secure storage module 718 and/or cryptographic logic module 720 can appear as a “black box” to the rest of controller 700. Thus, for instance, communication interface 716 can receive a message in encrypted form that it cannot decrypt and can simply deliver the message to processing subsystem 710. Processing subsystem 710 may also be unable to decrypt the message, but it can recognize the message as encrypted and deliver it to cryptographic logic module 720. Cryptographic logic module 720 can decrypt the message (e.g., using information extracted from secure storage module 718) and determine what information to return to processing subsystem 710. As a result, certain information can be available only within secure storage module 718 and cryptographic logic module 720. If secure storage module 718 and cryptographic logic module 720 are implemented on a single integrated circuit that executes code only from an internal secure repository, this can make extraction of the information extremely difficult, which can provide a high degree of security. Other implementations are also possible.

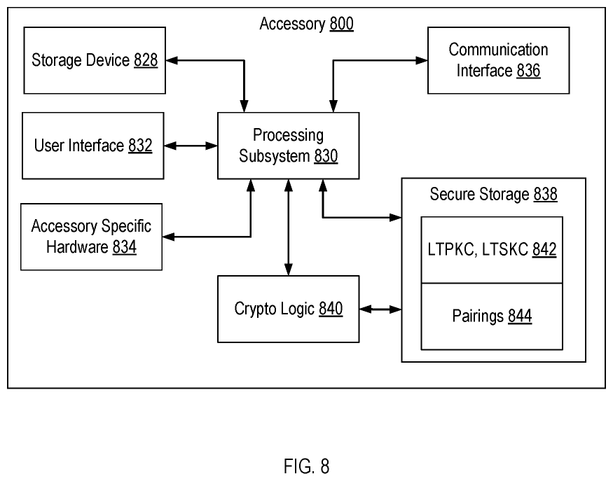

FIG. 8 shows a simplified block diagram of an example system architecture for accessory 800. Accessory 800 can implement any or all of the accessory functions, behaviors, and capabilities described herein, as well as other functions, behaviors, and capabilities not expressly described. Accessory 800 can include storage device 828, processing subsystem 830, user interface 832, accessory-specific hardware 834, communication interface 836, secure storage module 838, and cryptographic logic module 840. Accessory 800 can also include other components (not explicitly shown) such as a battery, power controllers, and other components operable to provide various enhanced capabilities.

Accessory 800 is representative of a broad class of accessories that can be operated by a controller such as controller 700, and such accessories can vary widely in capability, complexity, and form factor. Various accessories may include components not explicitly shown in FIG. 8, including but not limited to storage devices (disk, flash memory, etc.) with fixed or removable storage media; video screens, speakers, or ports for connecting to external audio/video devices; camera components such as lenses, image sensors, and controls for same (e.g., aperture, zoom, exposure time, frame rate, etc.); microphones for recording audio (either alone or in connection with video recording); and so on.

Storage device 828 can be implemented, e.g., using disk, flash memory, or any other non-transitory storage medium, or a combination of media, and can include volatile and/or non-volatile media. In some embodiments, storage device 828 can store one or more programs (e.g., firmware) to be executed by processing subsystem 830, including programs to implement various operations described above as being performed by an accessory, as well as operations related to particular accessory behaviors. Storage device 828 can also store an accessory object or accessory definition record that can be furnished to controller devices, e.g., during device discovery. Storage device 828 can also store accessory state information and any other data that may be used during operation of accessory 800.

Processing subsystem 830 can include, e.g., one or more single-core or multi-core microprocessors and/or microcontrollers executing program code to perform various functions associated with accessory 800. For example, processing subsystem 830 can implement various processes (or portions thereof) described above as being implemented by an accessory, e.g., by executing program code stored in storage device 828. Processing subsystem 830 can also execute other programs to control other functions of accessory 830. In some instances programs executed by processing subsystem 830 can interact with a controller (e.g., controller 700), e.g., by generating messages to be sent to the controller and/or receiving messages from the controller.

User interface 832 may include user-operable input devices such as a touch pad, touch screen, scroll wheel, click wheel, dial, button, switch, keypad, microphone, or the like, as well as output devices such as a video screen, indicator lights, speakers, headphone jacks, or the like, together with supporting electronics (e.g., digital-to-analog or analog-to-digital converters, signal processors, or the like). Depending on the implementation of a particular accessory 800, a user can operate input devices of user interface 832 to invoke functionality of accessory 800 and can view and/or hear output from accessory 800 via output devices of user interface 832. Some accessories may provide a minimal user interface or no user interface. at all. Where the accessory does not have a user interface, a user can still interact with the accessory using a controller (e.g., controller 700).

Accessory-specific hardware 834 can include any other components that may be present in accessory 800 to enable its functionality. For example, in various embodiments accessory-specific hardware 834 can include one or more storage devices using fixed or removable storage media; GPS receiver; power supply and/or power management circuitry; a camera; a microphone; one or more actuators; control switches; environmental sensors (e.g., temperature sensor, pressure sensor, accelerometer, chemical sensor, etc.); and so on. It is to be understood that any type of accessory functionality can be supported by providing appropriate accessory-specific hardware 834 and that accessory-specific hardware can include mechanical as well as electrical or electronic components.

Communication interface 836 can provide voice and/or data communication capability for accessory 800. In some embodiments communication interface 836 can include radio frequency (RF) transceiver components for accessing wireless voice and/or data networks (e.g., using cellular telephone technology, data network technology such as 3G, 4G/LTE, Wi-Fi, other IEEE 802.11 family standards, or other mobile communication technologies, or any combination thereof), components for short-range wireless communication (e.g., using Bluetooth and/or Bluetooth LE standards, NFC, etc.), and/or other components. In some embodiments communication interface 836 can provide wired network connectivity (e.g., Ethernet) in addition to or instead of a wireless interface. Communication interface 836 can be implemented using a combination of hardware (e.g., driver circuits, antennas, modulators/demodulators, encoders/decoders, and other analog and/or digital signal processing circuits) and software components. In some embodiments, communication interface 836 can support multiple communication channels concurrently or at different times, using the same transport or different transports.

Secure storage module 838 can be an integrated circuit or the like that can securely store cryptographic information for accessory 800. Examples of information that can be stored within secure storage module 838 include the accessory's long-term public and secret keys 842 (LTPKA, LTSKA as described above), and a list of paired controllers 844 (e.g., a lookup table that maps controller ID to controller long-term public key LTPKC for controllers that have completed a pair setup or pair add process as described above). In some embodiments, secure storage module 838 can be omitted; keys and lists of paired controllers can be stored in storage device 828.

In some embodiments, cryptographic operations can be implemented in a cryptographic logic module 840 that communicates with secure storage module 838. Physically, cryptographic logic module 840 can be implemented in the same integrated circuit with secure storage module 838 or a different integrated circuit (e.g., a processor in processing subsystem 830) as desired. Cryptographic logic module 840 can include various logic circuits (fixed or programmable as desired) that implement or support cryptographic operations of accessory 800, including any or all cryptographic operations described above. Secure storage module 838 and/or cryptographic logic module 840 can appear as a “black box” to the rest of accessory 800. Thus, for instance, communication interface 836 can receive a message in encrypted form that it cannot decrypt and can simply deliver the message to processing subsystem 830. Processing subsystem 830 may also be unable to decrypt the message, but it can recognize the message as encrypted and deliver it to cryptographic logic module 840. Cryptographic logic module 840 can decrypt the message (e.g., using information extracted from secure storage module 838) and determine what information to return to processing subsystem 830. As a result, certain information can be available only within secure storage module 838 and cryptographic logic module 840. If secure storage module 838 and cryptographic logic module 840 are implemented on a single integrated circuit that executes code only from an internal secure repository, this can make extraction of the information extremely difficult, which can provide a high degree of security. Other implementations are also possible.

Accessory 800 can be any electronic apparatus that interacts with controller 700. In some embodiments, controller 700 can provide remote control over operations of accessory 800 as described above. For example controller 700 can provide a remote user interface for accessory 800 that can include both input and output controls (e.g., a display screen to display current status information obtained from accessory 800 and an input control such as a touchscreen overlay to allow changes to the status information). Controller 700 in various embodiments can control any function of accessory 800 and can also receive data from accessory 800.

It will be appreciated that the system configurations and components described herein are illustrative and that variations and modifications are possible. It is to be understood that an implementation of controller 700 can perform all operations described above as being performed by a controller and that an implementation of accessory 800 can perform any or all operations described above as being performed by an accessory. A proxy, bridge, tunnel, or coordinator can combine components of controller 700 and accessory 800, using the same hardware or different hardware as desired. The controller and/or accessory may have other capabilities not specifically described herein (e.g., mobile phone, global positioning system (GPS), broadband data communication, Internet connectivity, etc.). Depending on implementation, the devices can interoperate to provide any functionality supported by either (or both) devices or to provide functionality that is partly implemented in each device. In some embodiments, a particular accessory can have some functionality that is not accessible or invocable via a particular controller but is accessible via another controller or by interacting directly with the accessory.

Further, while the controller and accessory are described herein with reference to particular blocks, it is to be understood that these blocks are defined for convenience of description and are not intended to imply a particular physical arrangement of component parts. Further, the blocks need not correspond to physically distinct components. Blocks can be configured to perform various operations, e.g., by programming a processor or providing appropriate control circuitry, and various blocks might or might not be reconfigurable depending on how the initial configuration is obtained. Embodiments of the present technologies described herein can be realized in a variety of apparatus including electronic devices implemented using any combination of circuitry and software.

### FURTHER EMBODIMENTS

While the technologies described herein have been described with respect to specific embodiments, one skilled in the art will recognize that numerous modifications are possible. Controller networks and/or accessory networks can include as many or as few devices as desired. Use of a proxy or coordinator is not required; regardless of the number of accessories or number of controllers, it is always possible (at least in principle) to establish pairings between each controller and each accessory and to have all controllers operate by controlling accessories directly. Where an accessory-network model (e.g., an environment model) is provided, each controller can obtain a copy of the model (e.g., via synchronization) and can provide access to the model through its user interface.

Further, where proxies or controllers are present, it can be but need not be the case that all controllers are permitted to access all accessories via the proxy or controller. Some controllers might be restricted from accessing accessories when not within the local environment, and some accessories might require that controllers access them directly rather than through a proxy or coordinator.

Embodiments of the present technologies described herein can be realized using any combination of dedicated components and/or programmable processors and/or other programmable devices. The various processes described herein can be implemented on the same processor or different processors in any combination. Where components are described as being configured to perform certain operations, such configuration can be accomplished, e.g., by designing electronic circuits to perform the operation, by programming programmable electronic circuits (such as microprocessors) to perform the operation, or any combination thereof. Further, while the embodiments described above may make reference to specific hardware and software components, those skilled in the art will appreciate that different combinations of hardware and/or software components may also be used and that particular operations described as being implemented in hardware might also be implemented in software or vice versa.

Computer programs incorporating various features of the present technologies described herein may be encoded and stored on various computer readable storage media; suitable media include magnetic disk or tape, optical storage media such as compact disk (CD) or DVD (digital versatile disk), flash memory, and other non-transitory media. (It is understood that “storage” of data is distinct from propagation of data using transitory media such as carrier waves.) Computer readable media encoded with the program code may be packaged with a compatible electronic device, or the program code may be provided separately from electronic devices (e.g., via Internet download or as a separately packaged computer-readable storage medium).

Thus, although the technologies described herein have been described with respect to specific embodiments, it will be appreciated that the disclosure is intended to cover all modifications and equivalents within the scope of the following claims.

What is claimed is:

1. A method, comprising:
receiving, by a first device, mode information that identifies a mode of operation for at least one device of a plurality of devices connected to a network within a geographic area;
determining, by the first device, based at least in part on the mode information, first setting information that identifies at least one setting for the at least one device of the one or more devices connected to the network;
identifying, by the first device, occurrence of a triggering action configured to instantiate the mode of operation;
instructing, by the first device and in response to identifying the occurrence of the triggering action, the at least one device to adjust one or more settings of the at least one device according to the first setting information;
identifying, by the first device, that a second device has come within the geographic area;
determining, by the first device, second setting information that identifies at least one setting for the second device based at least in part on the mode of operation and the second device being within the geographic area; and
instructing, by the first device, the second device to adjust one or more settings of the second device according to the second setting information.

2. The method of claim 1, wherein the first device is a controller.

3. The method of claim 1, wherein the first device is a resident device.

4. The method of claim 1, wherein the second device is a mobile device.

5. The method of claim 1, wherein the mode information further comprises the triggering action.

6. The method of claim 1, wherein the plurality of devices comprises at least one of an accessory or a controller.

7. The method of claim 1, wherein the geographic area comprises a home.

8. A controller device, comprising:
one or more memories; and
one or more processors in communication with the one or more memories and configured to execute instructions stored in the one or more memories to cause the controller device to:
receive mode information that identifies a mode of operation for at least one device of a plurality of devices connected to a network within a geographic area;
determine based at least in part on the mode information, first setting information that identifies at least one setting for the at least one device of the one or more devices connected to the network;
identify occurrence of a triggering action configured to instantiate the mode of operation;
instruct, in response to identifying the occurrence of the triggering action, the at least one device to adjust one or more settings of the at least one device according to the first setting information;
identify that a second device has come within the geographic area;
determine second setting information that identifies at least one setting for the second device based at least in part on the mode of operation and the second device being within the geographic area; and
instruct the second device to adjust one or more settings of the second device according to the second setting information.

9. The controller device of claim 8, wherein the geographic area comprises a room within a home.

10. The controller device of claim 9, wherein the one or more processors are further configured to determine third setting information that identifies at least one setting for a third device, the third device being outside the geographic area, the third device connected to the network.

11. The controller device of claim 8, wherein the geographic area is defined by a geofence.

12. The controller device of claim 8, wherein the first setting information comprises one or more respective states for one or more device characteristics of the at least one device.

13. A computer-readable storage medium having stored thereon program instructions that, when executed by one or more processors of a first controller device, cause the first controller device to perform operations comprising:
receiving mode information that identifies a mode of operation for at least one device of a plurality of devices connected to a network within a geographic area;
determining based at least in part on the mode information, first setting information that identifies at least one setting for the at least one device of the one or more devices connected to the network;
identifying occurrence of a triggering action configured to instantiate the mode of operation;
instructing, in response to identifying the occurrence of the triggering action, the at least one device to adjust one or more settings of the at least one device according to the first setting information;
identifying that a second device has come within the geographic area;
determining second setting information that identifies at least one setting for the second device based at least in part on the mode of operation and the second device being within the geographic area; and
instructing the second device to adjust one or more settings of the second device according to the second setting information.

14. The computer-readable storage medium of claim 13, wherein determining the second setting information is further based at least in part on a type of the second device.

15. The computer-readable storage medium of claim 14, wherein the second device is a tablet.

16. The computer-readable storage medium of claim 13, wherein determining the second setting information is further based at least in part on a category of the second device.

17. The computer-readable storage medium of claim 16, wherein the second device is a controller.

18. The computer-readable storage medium of claim 13, wherein the second setting information comprises a duration parameter that identifies a time after which second setting information will lapse.

19. The computer-readable storage medium of claim 13, wherein the second setting information comprises a location parameter that identifies locations where the second device is to implement the second setting information.

20. The computer-readable storage medium of claim 13, wherein the operations further comprise: receiving, from the second device, acceptance information indicating that the second device has adjusted one or more settings of the second device according to the second setting information.
